(19) United States
(12) Patent Application Publication
(10) Pub. No.: US 2009/0248796 A1
(43) Pub. Date: Oct. 1, 2009

(54) System and method for creating a punch list

(75) Inventors: Patrick R. Johnston, Vista, CA (US); David J. Glon, West Des Moines, IA (US); Kenneth R. Bonus, West Des Moines, IA (US); Greg E. Schulte, West Des Moines, IA (US); John Storey, Johnston, IA (US)

Correspondence Address: BRETT J. TROUT, PC, 516 WALNUT, DES MOINES, IA, 50309, US

(73) Assignee: The Weitz Company, LLC

(21) Appl. No.: 12/079,390

(22) Filed: Mar. 26, 2008

(51) Int. Cl. G06F 15/16; G06F 3/048

(52) U.S. Cl. 709/203; 715/764; 709/201

(57) ABSTRACT

A system and method for creating and utilizing an electronic construction punch list. A touch screen displaying a virtual floor plan is utilized to input and detail punch list items. The punch list information can then be transmitted to a contractor who uses the system to locate and address punch list items pursuant to the associated detail.

### BACKGROUND OF THE INVENTION

1. Field of the Invention

This invention relates to a system and method for generating an electronic punch list from a touch screen displaying a virtual floor plan. A user may locate punch list instructions on the virtual floor plan by touching the touch screen and output the electronic punch list to a contractor via electronic delivery.

2. Description of the Prior Art

Construction projects are not completed precisely to specification the first time around. Even those few projects that are completed to initial specifications may see those specifications change. The owner often withholds final payment for a project as a retainage until the owner's representative, typically an architect or engineer, confirms the entire project has been completed according to specifications. In the past, the owner's representative would perform a “walk through,” noting items such as cracks, paint and uncompleted items that the contract would have to address before the owner's representative would sign off on the project and the contract would receive the retainage. The punch list was printed on multiple sheets of paper. Once the contractor had addressed all of the items on the list, the owner's representative would perform a walk through and physically punch a hole through the sheets of paper beside each task as the owner's representative notes that the items on the list have been completed. More recently, owners and contractors have automated the process by using computers to store the list of items to address and then print out hard copies of the list for various subcontractors to address.

A problem with prior art punch lists is that they make it difficult for the owner's representative to accurately convey the location of punch list items. Prior art voice recorders have been used to dictate punch list instructions and locations. One problem associated with such voice recordings is that different users, using different voices and different location terminology, make it difficult for contractors to locate all of the punch list items.

Another problem associated with prior art voice recorders is that the voice recorders must be physically moved to an area where the voice data can be received and transcribed. Yet another drawback associated with such prior art voice recorders is the time, cost and difficulty associated with transcribing the punch list instructions. No dictation, even costly human transcription, is completely accurate. Inaccuracies in the transcription lead to delays associated with the owner's representative having to reconfirm the particularities of mistranscribed instructions.

Prior art mobile devices, such as phones, personal digital assistants and laptop computers can be used to receive punch list information at the project location. One drawback associated with using such prior art devices for recording punch list instructions is that each user uses different nomenclature to describe not only the punch list items, but their description as well. Without some way to positively identify the location of the punch list item, the owner runs the risk of delays, having the instruction overlooked or having the contractor execute the instruction at the wrong location, significantly increasing costs and delays. Additionally, even well written and consistent textual descriptions of location are more difficult to understand than graphical instructions.

While an owner's representative could take a hard copy of the floor plan to the actual location of the project to make the punch list, such hard copy punch lists have several drawbacks. Hard copy floor plans require hand writing, which is often difficult to decipher and loses detail in reproduction. Additionally, the unwieldy nature of full sized floor plans makes field use difficult, especially in situations where a large, flat horizontal surface is not available to make notations. Finally, given the size of floor plans, it is difficult for an owner's representative or contractor to carry and manipulate several floor plans at once.

### SUMMARY OF THE INVENTION

The present invention can relate, for example, to a graphical punch list that is interactively presented to a user of a computer system having a touch screen interface. In one embodiment, the graphical punch list may take the form of a dedicated computer application that identifies a punch list item identified on the touch screen by a user and locates a punch list instruction on the floor plan identified by the user as representative of an actual location at the construction project in need of work. The punch list item may include paint, repair, upgrades, etc. The punch list instruction may include textual or graphical indicia of an associated punch list item.

### BRIEF DESCRIPTION OF THE DRAWINGS

The present invention will now be described, by way of example, with reference to the accompanying drawings in which:

FIG. 1 illustrates a touch screen tablet computer displaying a user interface display for a virtual punch list application that may be an embodiment of the present invention;

FIGS. 2A, 2B and 2C illustrate a simplified flow chart of a computer application implementing a virtual punch list in accordance with some embodiments of the present invention;

FIG. 3 illustrates a schematic of the digital transfer of the virtual floor plan from the owner's representative to the contractor;

FIG. 4 illustrates an electrical outlet with a crack across its face;

FIG. 5 illustrates a simplified block diagram of a computer system implementing one or more embodiments of the present invention;

FIG. 6 illustrates the touch screen tablet computer of FIG. 1, displaying multiple pull down means for punch list items;

FIG. 7 illustrates the touch screen tablet computer of FIG. 1 displaying a user generating a custom punch list item button;

FIG. 8 illustrates the touch screen tablet computer of FIG. 1, displaying a punch list item market being located on the virtual floor plan;

FIG. 9 illustrates the touch screen tablet computer of FIG. 1, displaying a alternative virtual floor plan of the present invention illustrating punch list item markers as icons; and

FIG. 10 illustrates the touch screen tablet computer of FIG. 1, displaying a user relocating a punch list item button;

FIG. 11 illustrates the touch screen tablet computer of FIG. 1, displaying a user adding a notation to a punch list item button;

FIG. 12 illustrates the touch screen tablet computer of FIG. 1, displaying a read only version of the floor plan and hard copy printout;

FIG. 13 illustrates the touch screen tablet computer of FIG. 1, displaying a user adding a notation to the floor plan;

FIG. 14 illustrates the touch screen tablet computer of FIG. 1, displaying an explanatory note in response to a touch on the punch list item marker;

FIG. 15 illustrates the touch screen tablet computer of FIG. 1, displaying a blueprint, landscape and street construction as used in association with the computer system of the present invention; and

FIG. 16 illustrates various computer form factors that may be used in accordance with embodiments of the present invention.

### DETAILED DESCRIPTION OF THE PREFERRED EMBODIMENT

Punch list items comprise any item an entity wishes to have addressed after substantial completion of a construction project. Punch list items are typically identified before payment of the final retainage. In certain circumstances, punch list items may be addressed outside of this time frame, but most are confined to work the owner would like addressed before final payment is made. Punch list items may include electrical repairs, plumbing repairs, structural repairs and aesthetic repairs. Punch list items may also include updates, replacements or changes to the original project specification.

Typically, to create a punch list, the owner's representative does a “walk through” of a project after the contractor indicates that the project has reached the punch list phase. The owner's representative physically walks through the project, noting any repairs, replacements or needed changes along the way. The punch list process represents a delay during which the contractor is not receiving final payment and the owner is not receiving full benefit of the construction project. Anything to make the punch list process move more efficiently would benefit both the owner and the contractor.

The punch list process may be facilitated by clarifying communication between the owner's representative and the contractor. Similarly, decreasing the time interval between the owner 's representative creating the punch list and the contractor receiving the punch list will make the punch list process more efficient. Furthermore, allowing the owner's representative to more accurately convey the location of a punch list item to a contractor reduces delays and unnecessary repairs.

Therefore, disclosed herein is a virtual punch list that facilitates the fast, accurate delivery of punch list information between an owner's representative and a contractor by providing a virtual floor plan with drop down menus and a touch screen to physically locate punch list item markers on the virtual floor plan.

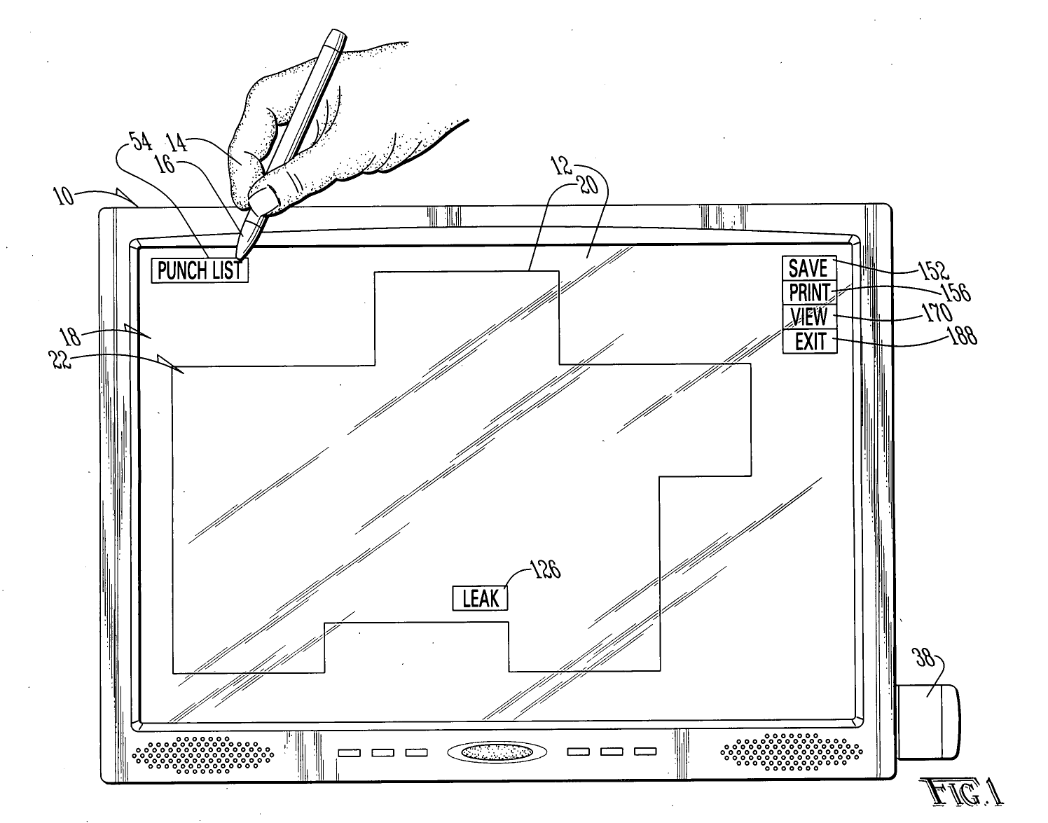

A touch screen tablet computer according to the present invention is shown generally as (10) in FIG. 1. The computer (10) may be of any suitable type known in the art. The computer (I 0) is provided with a touch sensitive screen (12). The screen (12) may be responsive to a user 's finger (14) or, as shown in the preferred embodiment, to a stylus (16). The user interface (18) displays a virtual floor plan (20). The user interface (18) utilizes standard active server pages (ASP) (22) as the server side programming language. The user interface (18) utilizes Javascript as the client side scripting language and SQL Server as the database.

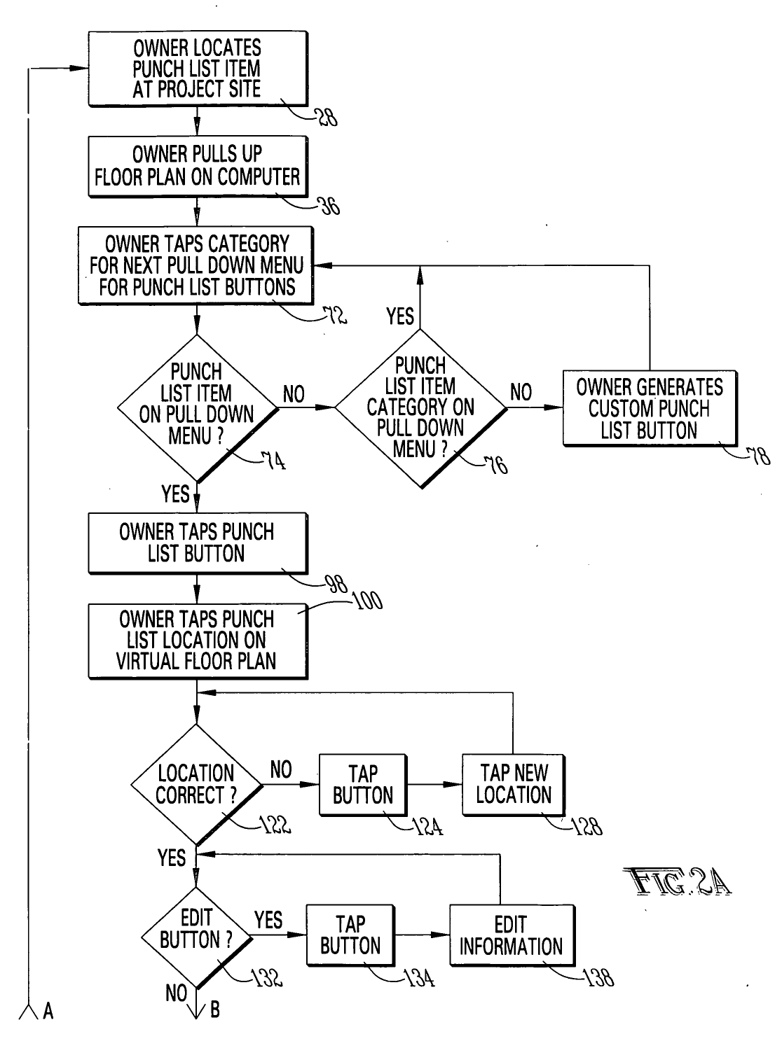

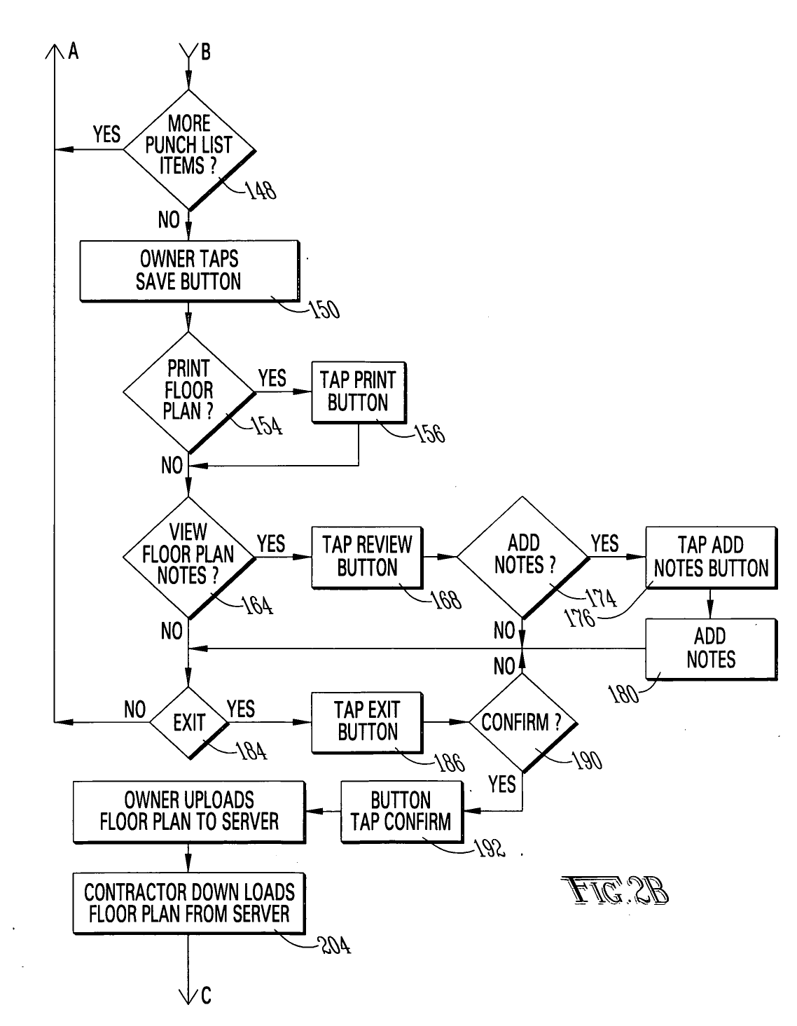

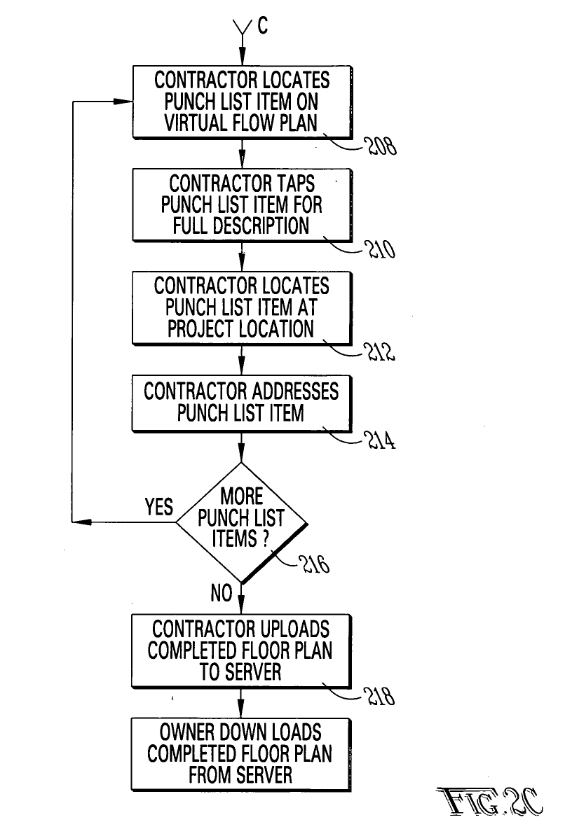

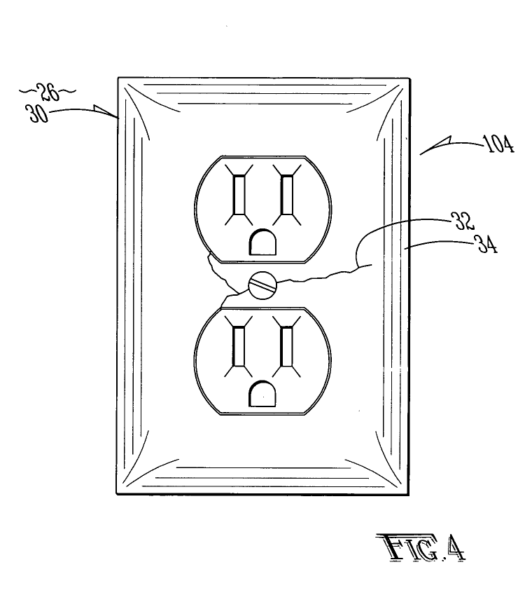

The flowchart in FIG. 2 shows the steps of generating a virtual punch list. To begin the process, a user (24), such as a construction project owner's representative, physically moves the computer (10) to a construction project site (26) and locates (28) a punch list item (30) at the site (26). (FIGS. 1-4). As shown in FIG. 4, the punch list item is a crack (32) in an outlet cover (34). The user (24) uses the computer (10) to access the Internet and pull up (36) the floor plan (20) associated with the site (26). Alternatively, the floor plan (20) may be preloaded on the computer (10) or loaded onto the computer via jump drive (38) or similar removable storage media. (FIGS. 1-2).

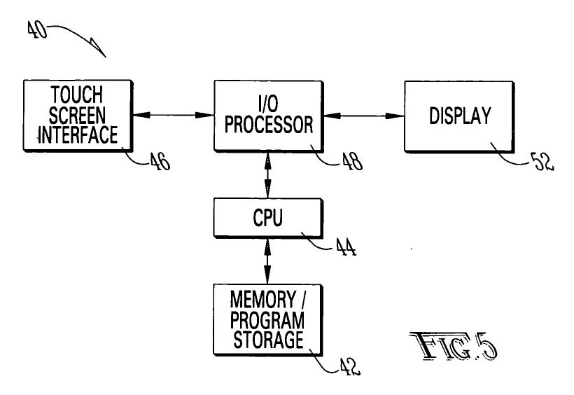

An exemplar computer system (40) having the program pre-loaded is illustrated in the schematic of FIG. 5. The program may be stored in a memory (42) of the computer system, including solid state memory (RAM, ROM, etc) hard drive memory, or other suitable memory. CPU (44) may retrieve and execute the program. CPR (44) may also receive input through the touch screen interface (46). In some embodiments, I/O processor (46) may perform some level of processing on inputs before they are passed to CPU (44). CPU (44) may also convey information to the user (24) or contractor (50) through display (52). In some embodiments, touch screen interface (46) and display (52) may be integrated into a single device, e.g. the touch screen (12).

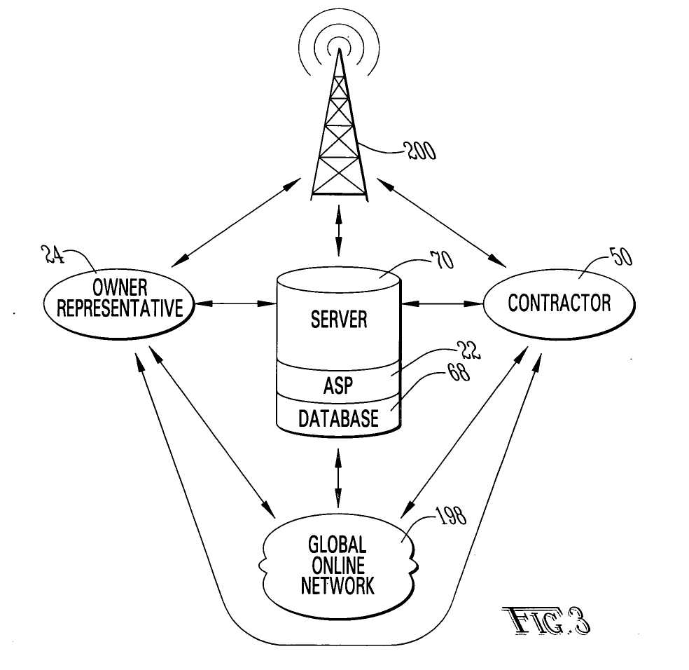

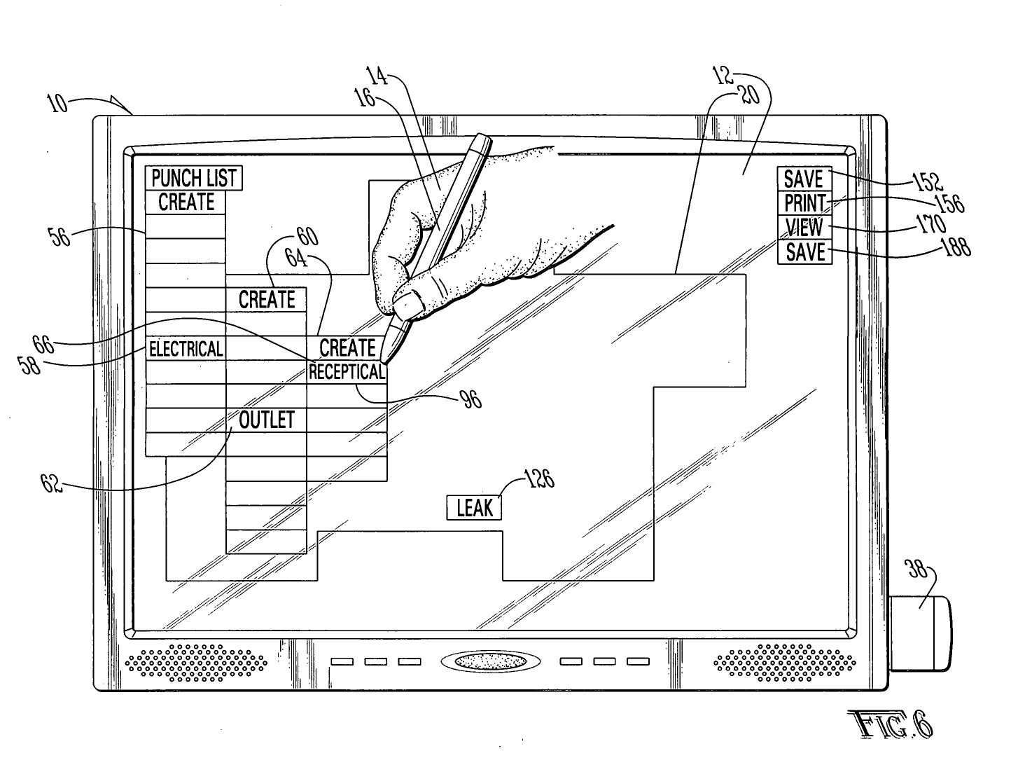

In the preferred embodiment, once the computer (10) is displaying the floor plan (20), the user (24) uses the stylus (16) to touch a header (54) opening (72) a pull down menu (56) displayed on the screen (12). If the punch list item (66) is on the pull down menu (56), the user (24) taps the virtual punch list item (66). If the virtual punch list item (66) is not (74) on the pull down menu (56), then from the pull down menu (56) the user (24) selects (76) a category (58), such as “electrical” with the stylus (16), which opens another pull down menu (60) of sub-categories. The user (24) selects a sub-category (62) which opens another pull down menu (64) of categories. From the pull down menu (64), the user (24) selects a virtual punch list item (66) corresponding to the actual punch list item, such as the crack (32) in the outlet cover (34). The pull down menus (56), (60) and (64) are derived from an HTML <select> item which is populated from a list of items preassigned to the pull down menus (56), (60) and (64) and saved on a database (68) associated with the active server pages (22) on a server (70). (FIGS. 3-6). Alternatively, the database (68) may be located within the memory (42) of the computer system (40). (FIG. 5).

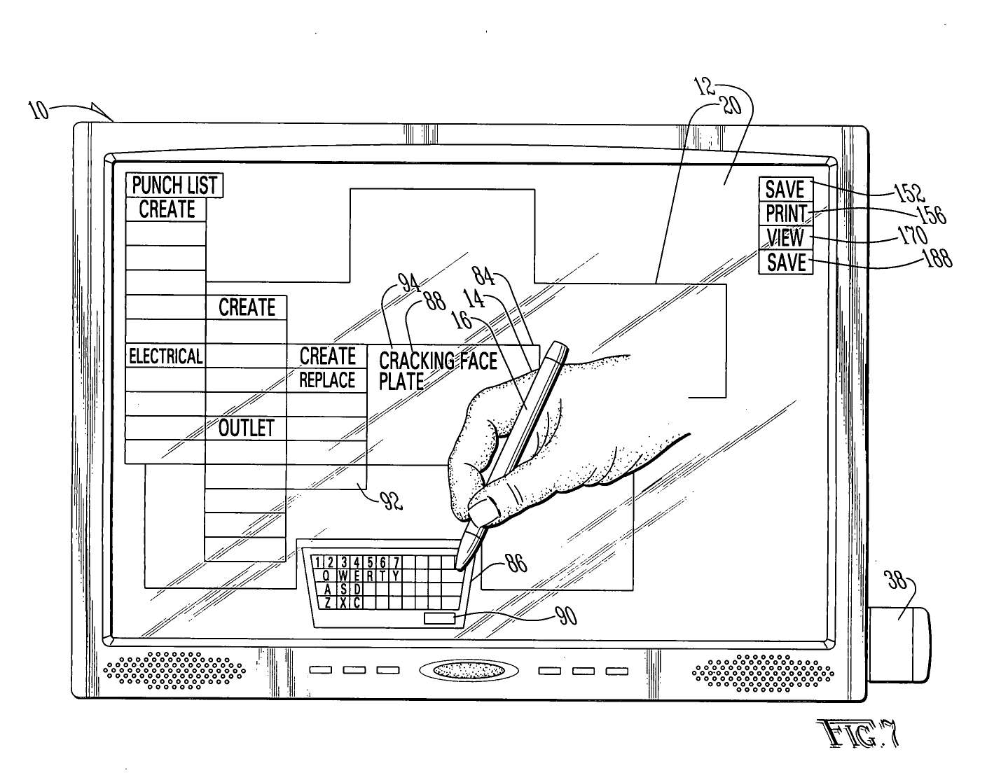

In the event the virtual punch list item (66) does not appear as either an item or a category on the last pull down menu (64), the user (24) can generate (78) a custom punch list button (92) (FIGS. 2 and 7). To generate (78) a custom punch list button (92), the user (24) selects the create tab (82) from the last pull down menu (64), which generates a text box (84) and a virtual keyboard (86). The user (24) then types a description of the punch list item (30) into the keyboard (86), causing text (88) to appear in the text box (84). (FIGS. 2, 4 and 7). Upon completion, the user (24) taps the virtual return key (90) on the virtual keyboard (86) with the stylus (16), thereby generating a custom punch list button (92) on the last pull down menu (64). If desired, user (24) may also designate a subcontractor to be associated with the custom punch list button (92). Once the custom punch list button (92) has been created, the custom punch list item (94) is added to the database (68) and associated with the floor plan (20) so that the pull down menu (64) is updated to include the custom punch list button (92).

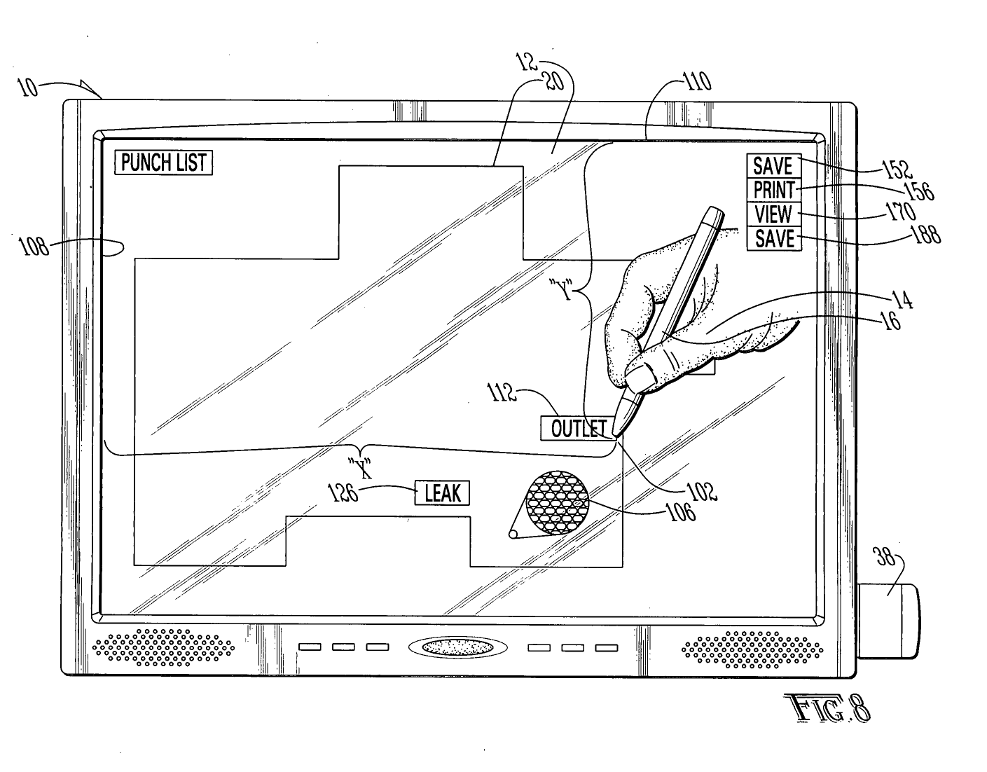

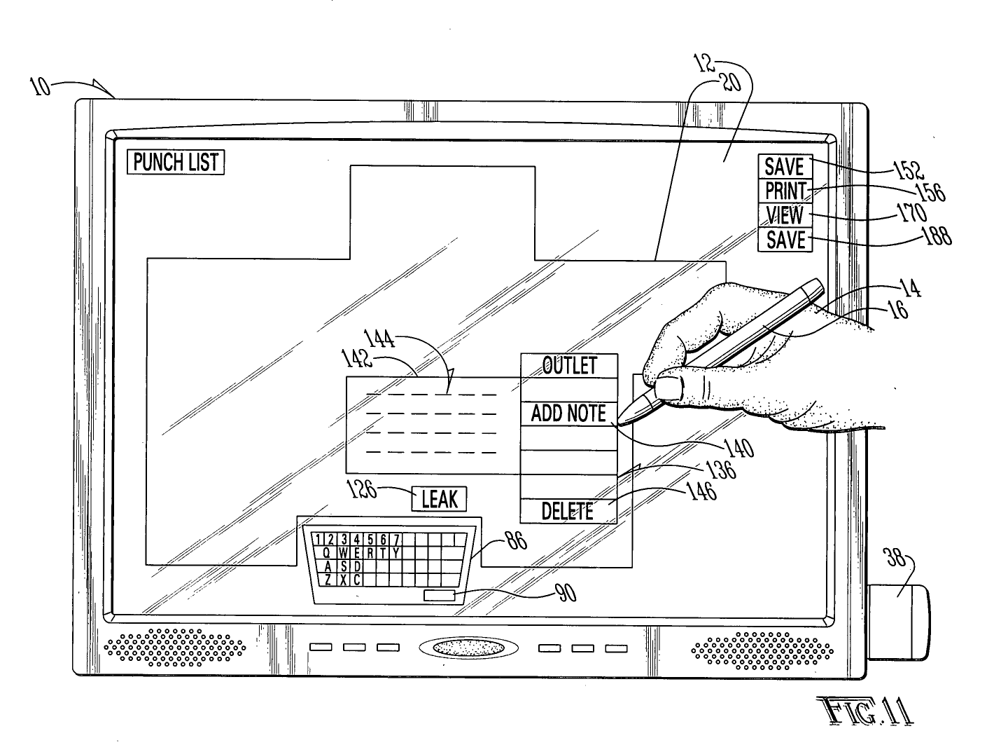

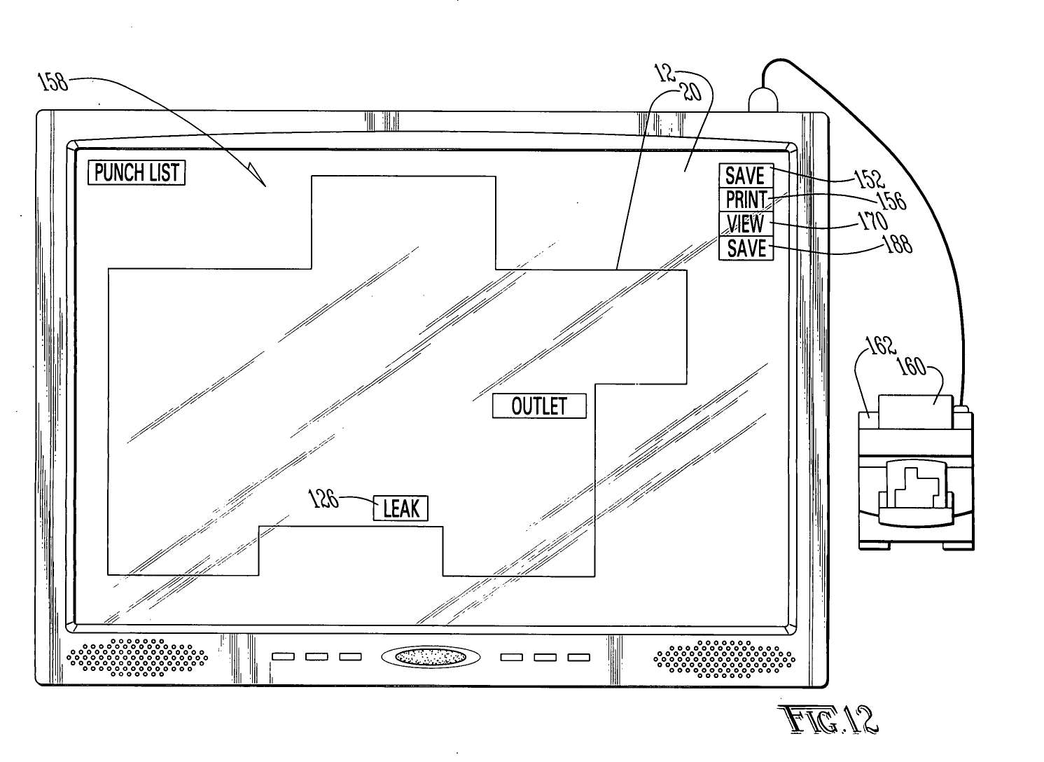

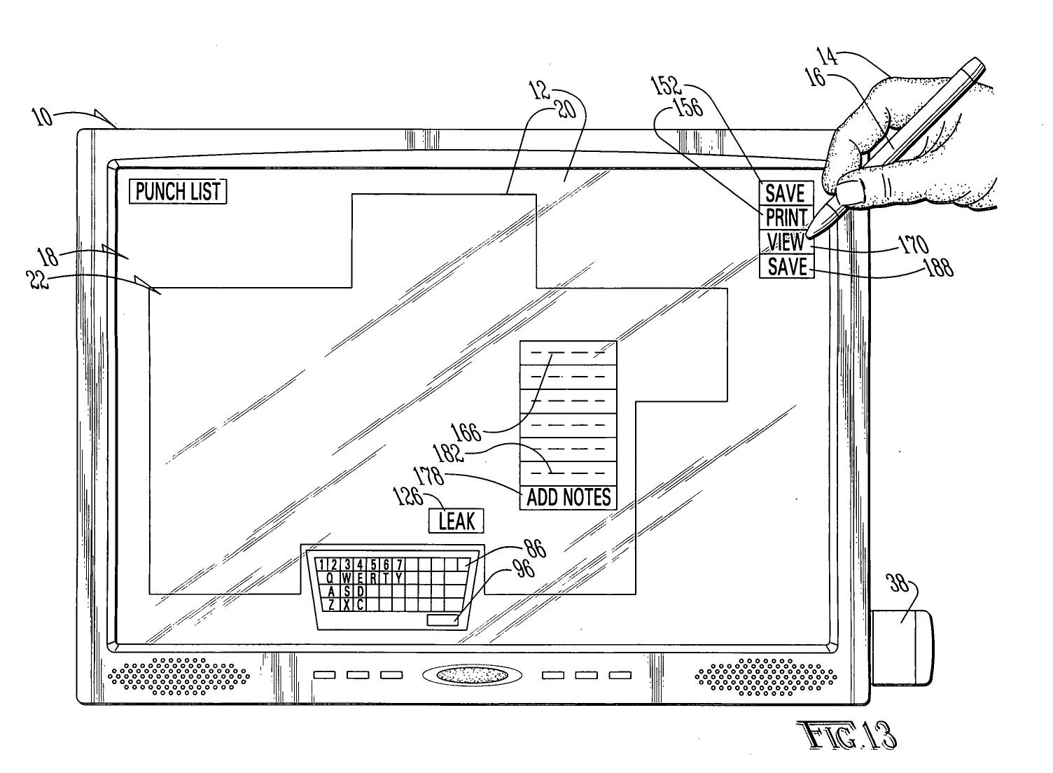

Once the virtual punch list item (66) has been located on a punch list button (96), or custom punch list button (92), the user (24) uses the stylus (16) to tap (98) and release the punch list button (96) or custom punch list button (92). When the user (24) taps the punch list button (96), the punch list item (30) is associated in the database (68) with the floor plan (20). As shown in FIG. 8, the user (24) taps (100) the location (102) on the virtual floor plan (20) corresponding to the general location (104) of the actual punch list item (30). (FIGS. 4 and 8). A more precise description of the item's (30) location may be provided in the text window (142) as described below. (FIGS. 8 and 11).

Once the user (24) taps (100) the location (1 02) on the virtual floor plan (20) corresponding to the location (104) of the punch list item (30) on the actual floor plan, the computer system (40) stores the information relating to the tap (100) in the database (68) as an (x,y) variable, where “x” is designated as the number of pixels (106) the tap (100) is from the left edge (108) of the screen (12), and “y” is designated as the number of pixels (106) the tap (100) is from the top edge (110) of the screen (12). Once the user (24) taps (100) the screen (12), the computer system (40) displays a button (112) at the location (102) of the tap (100).

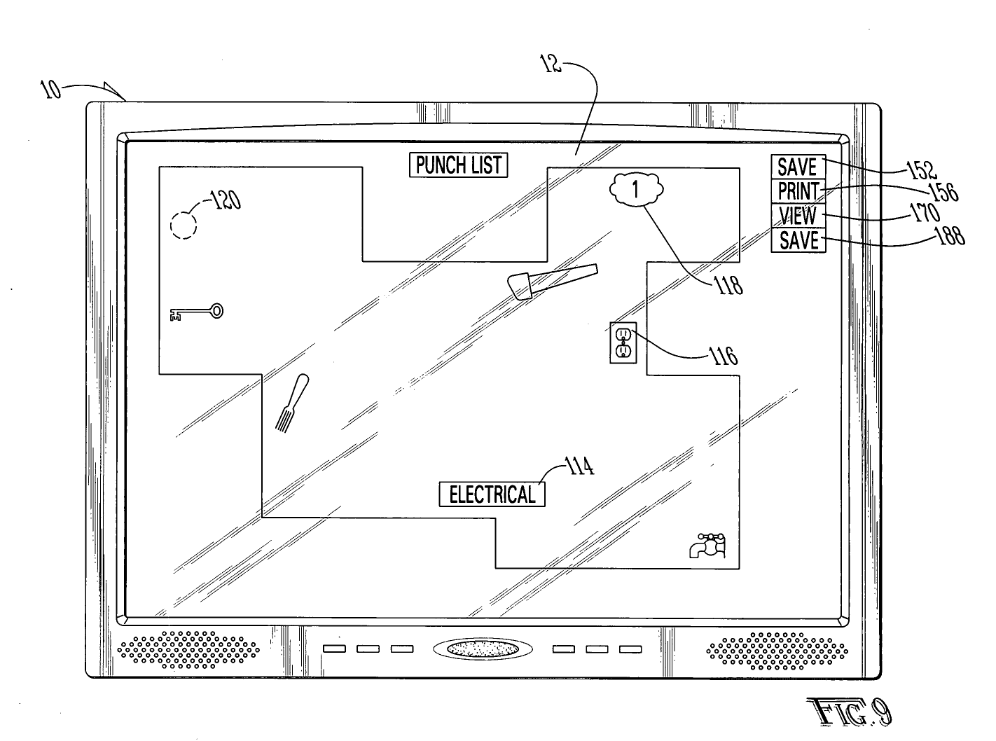

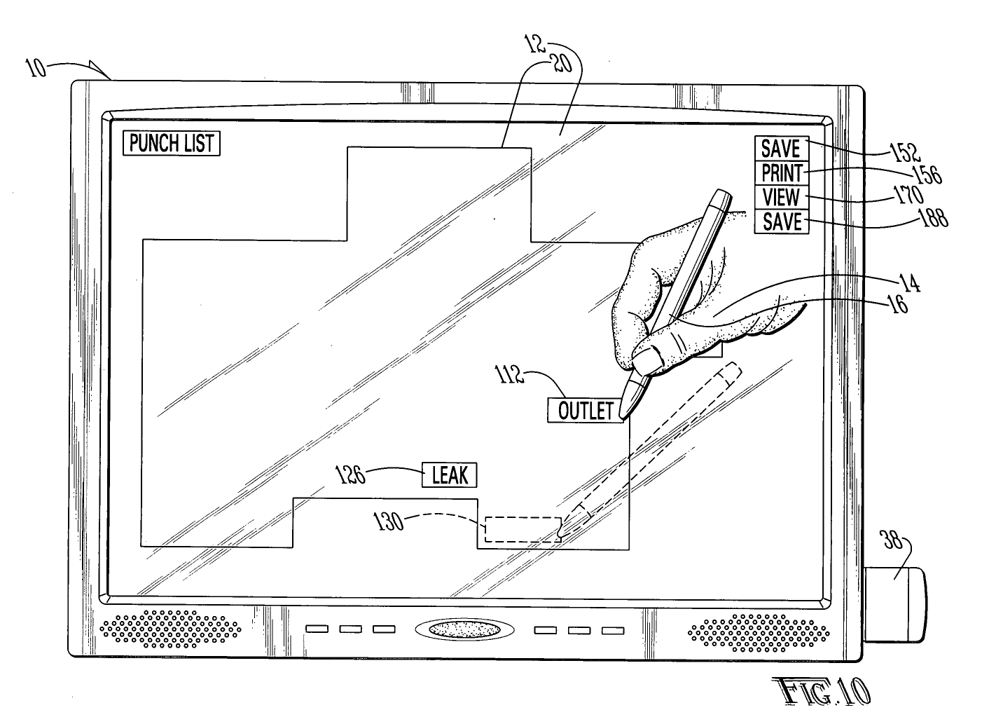

As shown in FIG. 9, the button (112) can be a text box (114), a graphical icon (116), a numbered cloud (118), or any other desired marker. If desired, the marker (120) may be invisible, appearing only when the screen (12) is contacted in the area of the marker (120), or may be turned on and off as a whole or by category. To move (122) a button (112), the user (24) merely taps (124) the button (112. The computer system (40) maintains each button (112) in an active or inactive state. By default, all buttons (112) are inactive and only one button (112) can be active at a time. Tapping (124) on the button (112) makes the button (112) active, while all other buttons (126) remain inactive. Once active, the computer system (40) uses Javascript event handlers to determine the new location where the user (24) taps (128) the screen (12). The computer system (40) then updates the button's (112) (x,y) variable in the database (68) and relocates the button (112) on the floor plan (20). The button (112) appears to the user (24) to be “on top” of the floor plan (20). The computer system (40) accomplishes this by using a different Z-index in the style for the <div> elements which contain the buttons (112) and the floor plan (20). The computer system (40) uses cascading style sheets (CSS) and styles for all <div> elements. Each button (112) and the floor plan (20) are wrapped in their own <div> element. The CSS interprets the Z-index to determine which items appear on top of other items. Tapping at a new location (130) when the button (112) is active, returns the item to an inactive state at the new position, giving the appearance of dropping the button (112) at the new location. (FIG. 10).

As shown in FIG. 11, if it is desired to edit (132) the button (112), tapping and holding (134) the button (112) for two seconds causes a menu box (136) to appear. The computer system (40) locates the menu box (136) based upon the (x,y) variable associated with the button (112). Options associated with the pull down menu (136) include, but at not limited to, viewing detail about the punch list item (30), deleting the button (112), viewing subcontractor information, creation date, de date, adding notes, etc. For instance, if the user (24) wants to edit (138) the button (112) by adding a note, the user (24) taps the add note button (140) from the pull down menu (136), causing a test window (142) and the keyboard (86) to appear. The user (24) types in the note (144) and taps the return button (90) to close the note (144). Alternatively, the user may use a pull-up window (not show) to capture hand written notes made by the user (24) with the stylus (16). Tapping the delete button (146) removes the button (112) from the screen (12). The button (112) is not removed from the database (68), however, until the user (24) determines (148) there are no more punch list items and saves the floor plan (20) by tapping (148) the save button (150).

In addition to saving the floor plan (20), the user has the option to print (154) the floor plan (20) by tapping the print button (156). The user (24) has the option of moving to an Internet based view only (158) version of the floor plan (20) where buttons (112) cannot be moved or to send the floor plan (20) to a printer (160) to print off a hard copy (162). Preferably, the hard copy (160) is generated from the view only floor plan (158) using a program such as ABCpdf, WebSupergoo or the like.

If it is desired to view (164) notes (166) associated with the floor plan (20), the user (24) taps (168) the view button (170) with the stylus (16), which causes the computer system (40) to display a text box (172) containing the notes (166). If it is desired to add (174) notes to the floor plan (20), the user (24) taps (176) the add notes button (178) which causes the computer system (40) to display the keyboard (86). The user (24) then uses the stylus (16) to add (180) the new notes (182) and taps the return button (90) to save the new notes (192) in the database (68) when the floor plan (20) is saved. When it is desired to exit (184) the floor plan (20), the user (24) taps (186) the exit button (188). Tapping (186) the exit button (188) causes the computer system (40) to remind the user (24) to save the floor plan (20) and to confirm the exit by tapping (192) the exit button (188) again. The computer system (40) uses the Javascript function “confirm” to achieve this functionality.

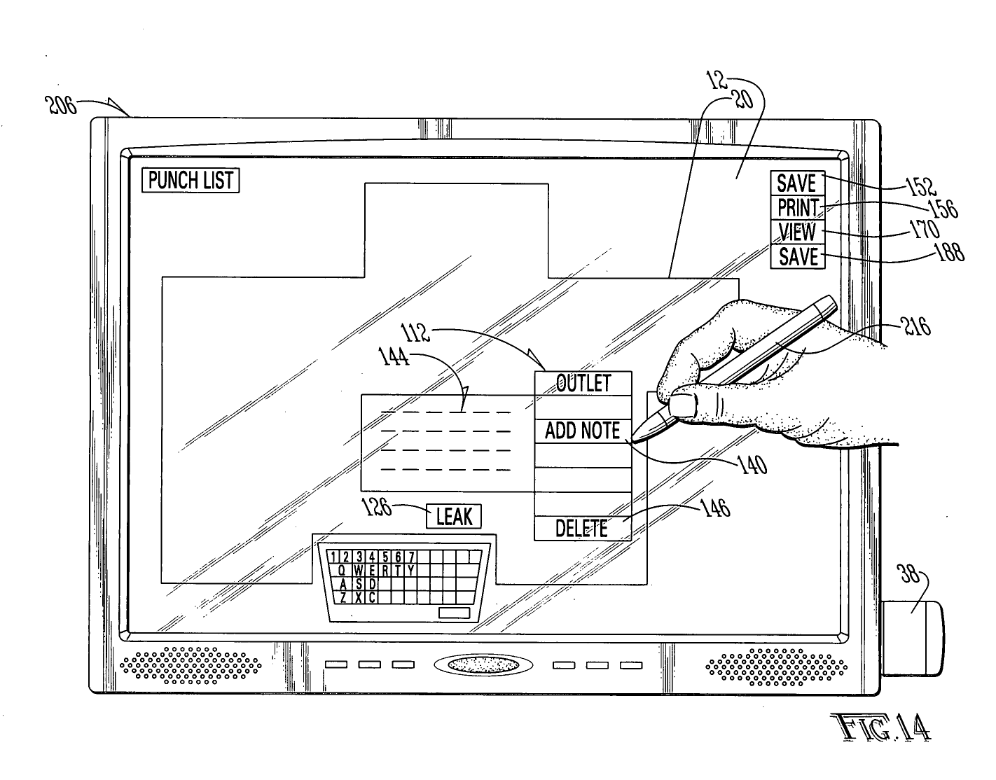

Once the floor plan (20) has been saved, the user (24) transmits the floor plan (20) to either a server (194) or directly to another user (196), such as a contractor (50). (FIGS. 1-3). The user (24) can physically deliver the computer (10) to the other user (196), or can transmit the floor plan (20) by email, file transfer, or any other desired method. Similarly, the user can transmit the floor plan (20) to the server (194) via a network (198), a wireless connection (200), a direct hardwired connection (202), or any combination thereof. When another user (196), or the same user (24), wishes to address the punch list items (30), the user (196) downloads (204) the floor plan (20) from the server (194 onto a touch screen tablet computer (206) using any of the methods described above in uploading the floor plan to the server (194). (FIG. 14).

The user (196) takes the computer (206) back to the actual location (104) of the punch list item (30) and locates (208) the virtual location (102) of the punch list button (112) on the floor plan (20). The user (196) then taps (210) the button (112) to reveal the notes (144) about the punch list item (66). The user (196) uses this information to locate (212) the actual punch list item (30) at the construction project site (26) and address the punch list item (30) per the notes (I 44). The user (196) then reviews (216) the floor plan (20) for more punch list items (66), locating and addressing them in a similar manner.

As each punch list item (66) is addressed, the user (196) taps the add note button (140) with a stylus (216), updating the note (144) with the keyboard (86) to reflect completion or note problems. Alternatively, the user (196) may delete the button (112) by tapping the delete button (146) upon addressing the punch list item (30). Once all of the punch list items (30) have been addressed, the user (196) saves the floor plan (20) using the save button (152) and uploads (218) the floor plan (20) to the server (194) or the computer (10) in a manner described above.

The user (24) can then access the floor plan (20) and visit the construction project site (26) to determine if all of the punch list items (30) have been adequately addressed and pay the user (196) any outstanding retainage.

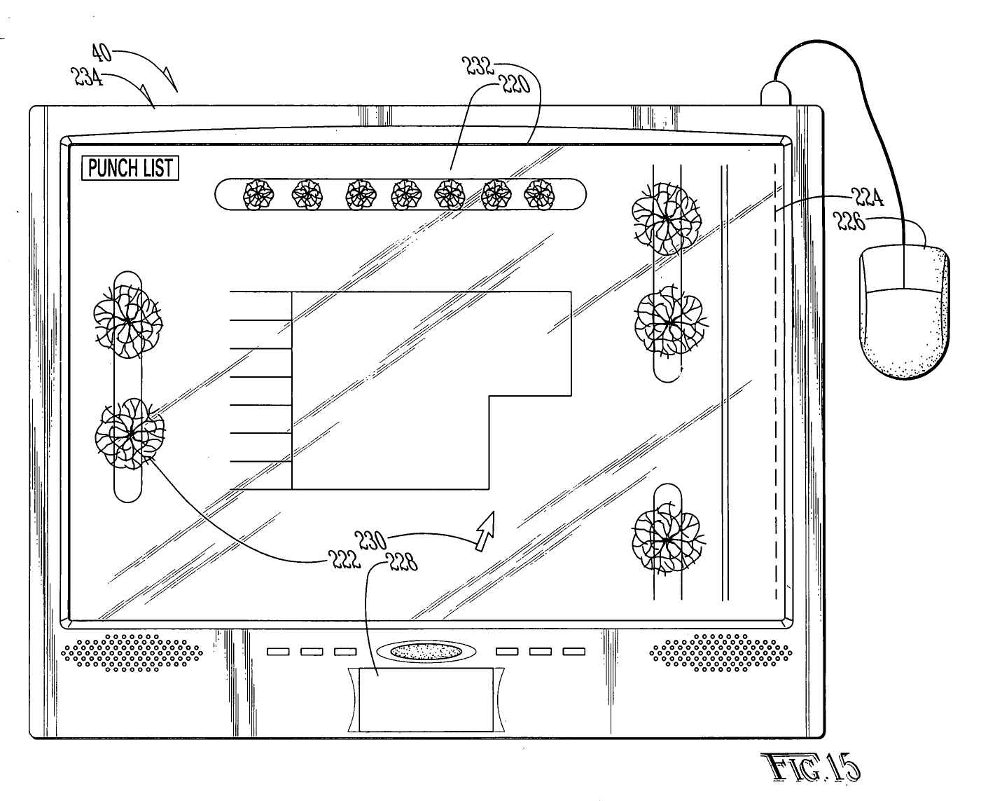

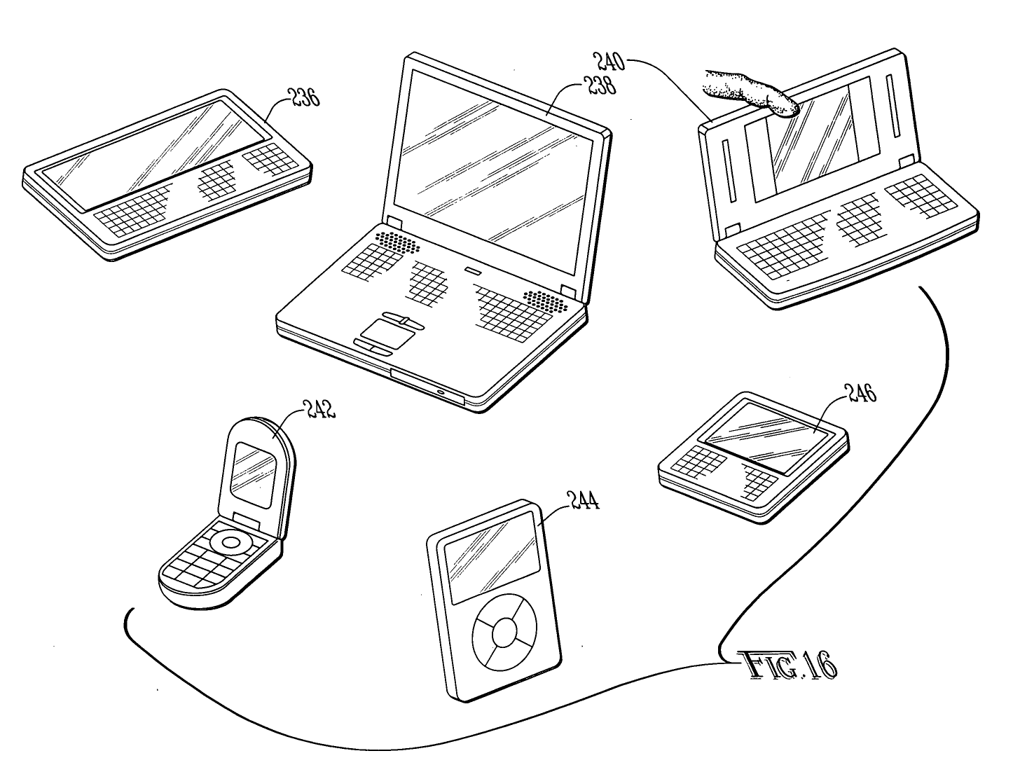

As shown in FIG. 15, the computer system (40) of the present invention can be used in association with blueprints (220), as well as landscaping (222) and road plans (224). Also, as shown in FIG. 15, the system may be used with a computer mouse (226) or a touch screen (228) to move a cursor (230) around the screen (232) of a computer (234). The computer system (40) may be of any variety of types illustrated in FIG. 16, including handheld computers (236), notebook computers (238), multimedia phones (240), cell phones (242), media players (244) or personal digital assistants (246). The computer system (40) may also be a combination of these types, such as a combination of a personal digital assistant, media player and telephone.

Although the invention has been described with respect to a preferred embodiment thereof, it is to be understood that it is not to be so limited since changes and modifications can be made therein which are within the fall, intended scope of this invention as defined by the appended claims. For example, the floor plan and all of the punch list items (66) can be stored in the memory (42) of the computer (10) with the computer (10) running the active server page (22) without the need for access to the Internet.

The present invention may also be used in association with dollar amounts to track costs associated with punch list items. Additionally, the present invention may be used to track “as built” changes made during construction and for requests for information (ROI) to transmit information regarding questions about the construction project.

What is claimed is:

1. A computer system having a touch-sensitive interface and a graphical user interface, wherein the computer system includes a computer memory encoded with executable instructions causing the computer system to:
(a) display a floor plan;
(b) identify an instruction at a predetermined position on said floor plan selected by a touch on the touch-sensitive interface;
(c) generate a file associating said instruction at said predetermined position on said floor plan;
(d) transfer said file to a supplemental computer; and
(e) thereby providing a remote user such floor plan with said instruction at said predetermined position on said floor plan.

2. The computer system of claim 1, wherein said instruction is a punch list instruction.

3. The computer system of claim 1, wherein said computer system weighs less than three kilograms.

4. The computer system of claim 1, wherein said computer system weighs less than one kilogram.

5. The computer system of claim 1, wherein the computer system is a touchpad computer.

6. The computer system of claim 1, wherein the computer system comprises:
(a) a network database;
(b) means for downloading said file from said computer system to said network database; and
(c) means for accessing said file from said network database.

7. The computer system of claim 1, wherein said executable instructions further cause the computer system to locate said instruction at said predetermined position on said floor plan in the form of an icon.

8. The computer system of claim 7, wherein said icon is graphical.

9. The computer system of claim 7, wherein said executable instructions further cause the computer system to generate a textual description of said instruction in response to a touch on the touch-sensitive interface on said icon.

10. The computer system of claim 1, wherein the executable instructions further cause the computer system to:
(a) identify an information position on the touch-sensitive interface identifying the instruction where a user touches and removes a pointer from contact with the touch sensitive interface;
(b) store information regarding said instruction in memory;
(c) identify said predetermined position on the touch-sensitive interface where the user touches and removes said pointer from contact with the touch-sensitive interface; and
(d) associate a visual representation of the instruction at said predetermined position.

11. A method of associating an instruction with a floor plan, the method comprising:
(a) providing a computer system having a touch-sensitive interface and a graphical user interface;
(b) storing a floor plan on said computer system;
(c) locating said computer system within ten meters of a structure represented by said floor plan;
(d) identifying a portion of said structure to be changed;
(e) touching and releasing said touch-sensitive interface at a first point associated with a change instruction;
(f) touching and releasing said touch sensitive interface at a second point on said floor plan representing said portion of said structure to be changed;
and
(g) generating a file on said computer system associating said change instruction with said second point on said floor plan.

12. The method of associating an instruction with a floor plan of claim 11, using information from said file to identify said portion of said structure to be changed and changing said portion of said structure to be changed in accordance with said change instruction.

13. The method of associating an instruction with a floor plan of claim 11, further comprising downloading said file to a network database located at least five kilometers from said structure to be changed.

14. The method of associating an instruction with a floor plan of claim 11, wherein said computer system weighs less than three kilograms.

15. The method of associating an instruction with a floor plan of claim 11, wherein the computer system is a touchpad computer.

16. A computer system having a touch-sensitive interface and a graphical user interface, wherein the computer system includes a computer memory encoded with executable instructions causing the computer system to:
(a) display a floor plan;
(b) identify an instruction selected by a user typing and releasing said instruction displayed on the touch-sensitive screen; and
(c) locate said instruction at a predetermined position on said floor plan in response to said user typing and releasing the touch screen at said predetermined position on said floor plan, thereby providing to the user a floor plan with said instructions at said predetermined position on said floor plan.

17. The computer system of claim 16, wherein the executable instructions further cause the computer to:
(a) generate a file associating said instruction at said predetermined position on said floor plan; and
(b) transfer said file to a supplemental computer, thereby providing to a remote user said floor plan with said instruction at said predetermined position on said floor plan.

18. The computer system of claim 16, wherein said instruction is a punch list instruction.

19. The computer system of claim 16, wherein said instruction is a request for information.

20. The computer system of claim 16, wherein said instruction is an as built instruction.
